(19) United States
(12) Patent Application Publication
(10) Pub. No.: US 2013/0336018 A1
(43) Pub. Date: Dec. 19, 2013

(54) CONVERTER

(71) Applicant: TDK Corporation, Tokyo (JP)

(72) Inventors: LiGang PENG, Shanghai (CN); Xin ZHOU, Shanghai (CN)

(21) Appl. No.: 13/915,033

(22) Filed: Jun. 11, 2013

(30) Foreign Application Priority Data
Jun. 15, 2012 (CN) 201210201891.8

(51) Int. Cl. H02M 3/335

(52) U.S. Cl. CPC H02M 3/33507
USPC 363/21.04; 363/21.12

(57) ABSTRACT

A converter is configured with a transformer that has a primary coil and a secondary coil, a first switching element that is serially connected to the primary coil, a control circuit that controls the first switching element, and a firs rectifying element that supplies electric power to the control circuit. A ground potential of the control circuit and the first rectifying element are connected to the primary coil at different points. Accordingly, an inverter is miniaturized and manufacturing costs are reduced.

### CROSS-REFERENCE TO RELATED APPLICATION

This application claims priority to Chinese Patent Application No. 201210201891.8 filed Jun. 15, 2012 which is hereby expressly incorporated by reference herein in its entirety.

### BACKGROUND

The present invention relates to a converter. Specifically, the present invention relates to miniaturization of a transformer in regards to a flyback converter and a forward converter.

Recently, small-sized converters are often used, for instance, as a power source for a communication device. FIG. 12 shows a schematic circuit diagram of a conventional flyback converter. The conventional converter 1H shown in FIG. 12 is configured with an input terminal Vin, an input capacitor C1, a transformer T1, a smoothing capacitor C2, a switching element Q1, a control circuit Ic, an auxiliary coil Nb, a first rectifying element (diode) D1 and a second rectifying element (diode) D2. Specifically, the transformer T1 has a primary coil Np and a secondary coil Ns. The control circuit Ic controls the switching element Q1. The auxiliary coil Nb transmits electric power to the control circuit Ic when the primary coil is turned OFF. The first rectifying element D1 supplies electric power to the control circuit Ic. Further, the second rectifying element D2 supplies electric power to an output terminal Vout.

An operation of the converter 1H will be explained below with references to FIGS. 12-15.

First, in the converter 1H, an electric current Ip shown in FIG. 13 flows from the input terminal Vin to a primary side of the transformer T1 while the switching element Q1 is turned ON. At this time, the first rectifying element D1 and the second rectifying element D2 are biased in a backward direction. During this period, because a voltage, which is equal to a voltage between both sides of the capacitor C1, is applied to the primary coil Np, the electric current Ip flows in the primary coil Np. As a result, energy is accumulated in the transformer T1.

Next, while the switching element Q1 is turned OFF, the first rectifying element D1 and the second rectifying element D2 are biased in a forward direction. As a result, an electric current Is shown in FIG. 14 flows in a secondary side of the transformer T1. Further, an electric current Ib flows in the auxiliary coil Nb. During this period, energy is supplied to the output terminal Vout through the secondary coil Ns. Further, energy is supplied to the control circuit Ic through the auxiliary coil Nb.

FIG. 15 is a waveform diagram that shows a voltage V_{NP}, the electric current Ip, the output electric current Is and the control circuit supply electric current Ib. Specifically, the voltage V_{NP} is applied to the primary coil Np. The electric current Ip flows in the primary coil Np. The output electric current Is is supplied to the output terminal Vout through the secondary coil Ns. Further, the control circuit supply electric current Ib is supplied to the control circuit Ic through the auxiliary coil Nb. In FIG. 15, “Ton” corresponds to an ON period of the switching element Q1 and “Toff” corresponds to an OFF period of the switching element Q1. In the ON period Ton of the switching element Q1, the voltage V_{NP} is applied to the primary coil Np. As a result, the electric current Ip, which flows in the primary coil Np, gradually increases. When the switching element Qi is turned OFF, the output electric current Is that is generated by an induced voltage of the secondary coil Ns and the control circuit supply electric current Ib that is generated by an induced voltage of the auxiliary coil Nb flow. Then, during the OFF period Toff of the switching element Q1, the output electric current Is and the control circuit supply electric current Ib gradually decrease. When a capacitor Cb is completely charged, a change of the control circuit supply electric current Ib is stopped. The dotted line shows a waveform in an electric current consecutive mode. A solid line shows a waveform in an electric current discontinuous mode. During the OFF period Toff of the switching element Q1, energy, which is accumulated in the transformer T1, is supplied to the control circuit Ic and the output terminal Vout.

In the conventional converter as explained above, there are problems, such as increasing manufacturing costs and increasing a size of the transformer because an auxiliary winding needs to be installed. Another problem is that a space for a main coil is limited because of the installment of the auxiliary winding. Further, because the auxiliary winding does not contribute to the transfer of energy, the space is used in vain.

The present invention seeks to solve these problems. The purpose of the present invention is to miniaturize a converter and reduce cost. An object of the present invention is to provide a converter in which at least a part of a primary coil functions as an auxiliary winding without having the auxiliary winding in the converter.

### SUMMARY

The present invention seeks to resolve the above problems. A converter according to the present invention includes: a transformer that has a primary coil and a secondary coil; a first switching element that is serially connected to the primary coil; a control circuit that controls the first switching element; and a first rectifying element that supplies electric power to the control circuit. A ground potential of the control circuit and the first rectifying element are connected to the primary coil at different points.

In the converter, the first rectifying element is connected to the primary coil so that an electric current flows in the first rectifying element when the first switching element is turned OFF.

Further, the converter may be a flyback converter or a forward converter.

Further, a capacitor may be connected between an electric power supply terminal and the ground potential of the control circuit.

Further, the primary coil may be divided into a plurality of coils.

Further, the primary coil may be connected between the electric power supply terminal and the ground potential of the control circuit.

Further, the ground potential of the control circuit may be directly connected to the first switching element or the ground potential of the control circuit may be connected to the first switching element through a first resistor.

Further, the primary coil may be divided into a first primary coil and a second primary coil, and the first switching element may be provided between the first primary coil and the second primary coil.

Further, the primary coil may be divided into a first primary coil, a second primary coil and a third primary coil. A first resistor may be serially connected to the primary coil. A second switching element may be connected to the first resistor in parallel. The third primary coil may be connected to a drive circuit, which drives the second switching element, through a second rectifying element that is different from the first rectifying element.

According to the converter of the present invention, the converter can be miniaturized and the manufacturing costs can be reduced.

### BRIEF DESCRIPTION OF THE DRAWINGS

FIG. 1 is a circuit diagram that shows a converter 1A according to a first embodiment of the present invention.

FIG. 2 is an equivalent circuit diagram that shows the converter 1A shown in FIG. 1 when a first switching element Q1 is turned ON.

FIG. 3 is an equivalent circuit diagram that shows the converter 1A shown in FIG. 1 when a first switching element Q1 is turned OFF.

FIG. 4 is a waveform diagram that shows a total voltage V (Np1+Np2), an electric current Ip, an output electric current Is and a control circuit supply electric current Inp2 in the converter 1A shown in FIG. 1.

FIG. 5 is a circuit diagram that shows a converter 1B according to a second embodiment of the present invention.

FIG. 6 is a circuit diagram that shows a converter 1C according to a third embodiment of the present invention.

FIG. 7 is a circuit diagram that shows a detailed configuration of the converter 1C shown in FIG. 6.

FIG. 8 is a circuit diagram that shows a converter 1D according to a fourth embodiment of the present invention.

FIG. 9 is a circuit diagram that shows a converter 1E according to a fifth embodiment of the present invention.

FIG. 10 is a circuit diagram that shows a converter 1F according to a sixth embodiment of the present invention.

FIG. 11 is a circuit diagram that shows a converter 1G according to a seventh embodiment of the present invention.

FIG. 12 is a circuit diagram that shows a conventional converter 1H.

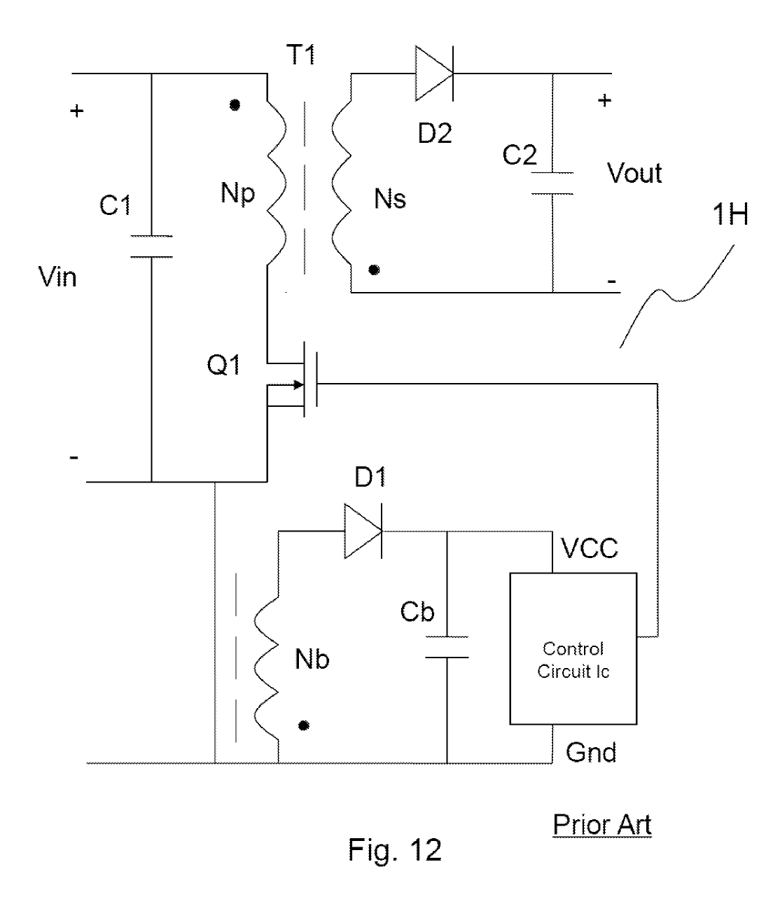

FIG. 13 is an equivalent circuit diagram that shows the conventional converter 1H of FIG. 12 when a first switching element Q1 is turned ON.

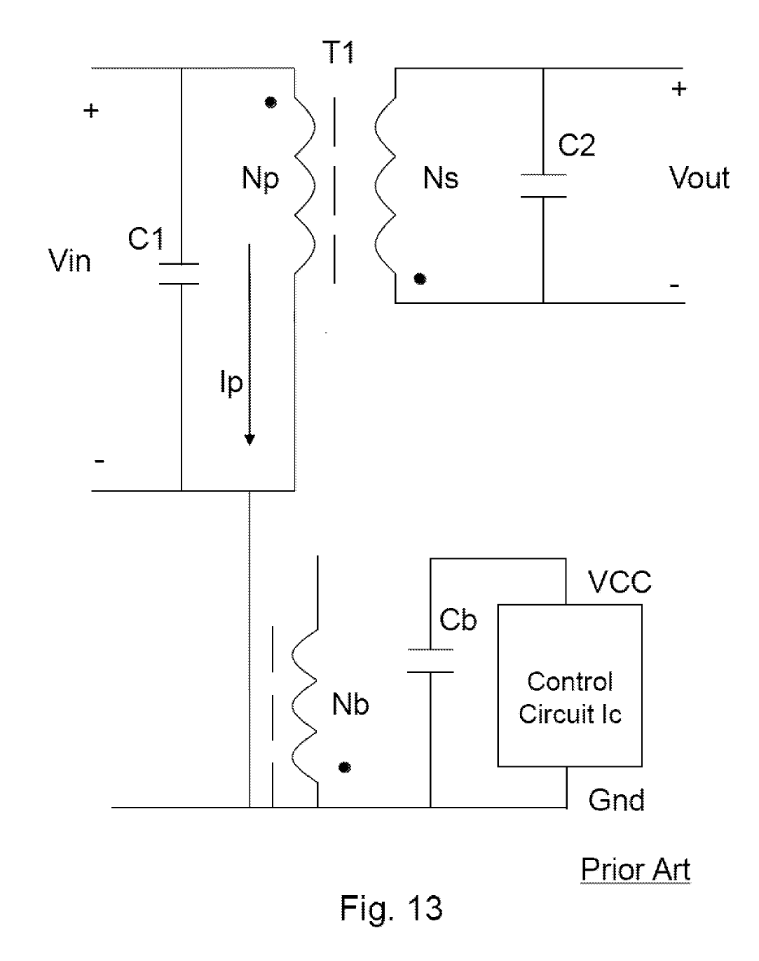

FIG. 14 is an equivalent circuit diagram that shows the conventional converter 1H of FIG. 12 when a first switching element Q1 is turned OFF.

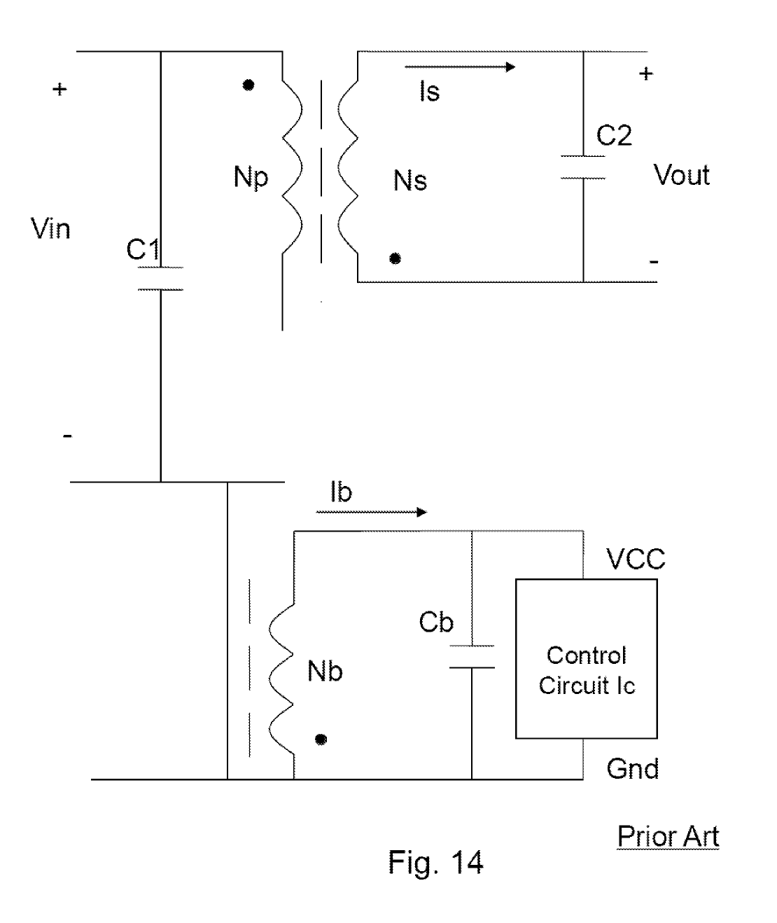

FIG. 15 is a waveform diagram that shows a voltage V_{NP}, an electric current Ip, an output electric current Is and a control circuit supply electric current Ib in the conventional converter 1H of FIG. 12.

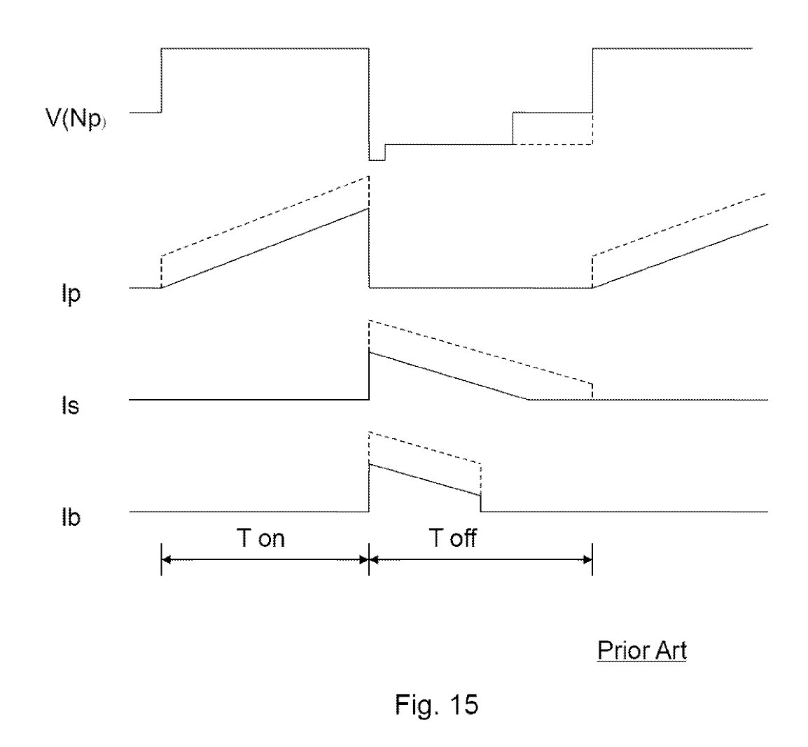

### DESCRIPTION OF EXEMPLARY EMBODIMENT

Embodiments of the present invention are explained below with reference to the drawings.

### First Embodiment

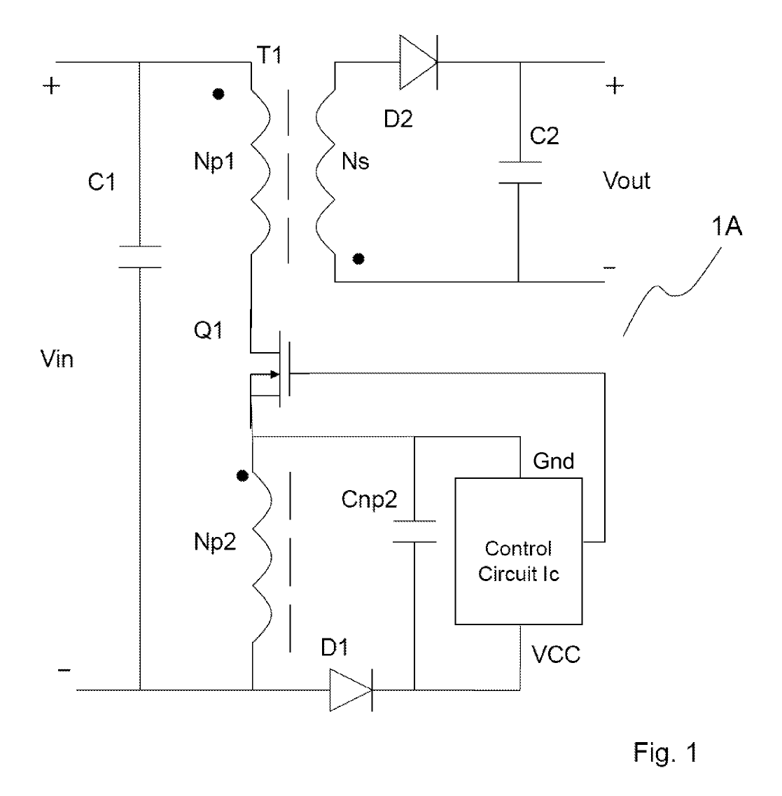

FIG. 1 is a circuit diagram that shows a converter 1A according to a first embodiment of the present invention. The converter 1A shown in FIG. 1 corresponds to a flyback converter. Further, the winding directions of primary coils Np1, Np2 and a winding direction of a secondary coil Ns are opposite to one another. The converter 1A is configured with an input capacitor C1, a transformer T1, a capacitor C2, a first switching element Q1, a control circuit Ic, a first rectifying element (diode) D1 and a second rectifying element (diode) D2. Specifically, the transformer T1 has primary coils Np1, Np2 and secondary coil Ns. The first switching element Q1 is connected in series to the primary coils Np1 and Np2. The control circuit Ic controls the first switching element Q1. The first rectifying element D1 supplies electric power to the control circuit Ic. Further, the second rectifying element D2 supplies electric power to an output terminal Vout. A ground potential Gnd of the control circuit Ic and the first rectifying element D1 are connected to the primary coils Np1 and Np2 at different points. Further, a capacitor Cnp2 is connected between a power supply terminal VCC of the control circuit Ic and the ground potential Gnd. The control circuit Ic is configured with, for example, a chip that performs turn ON and OFF operations of the first switching element Q1 by a predetermined duty ratio. In the first embodiment of the present invention shown in FIG. 1, the primary coil is divided into the coil Np1 (first primary coil) and the coil Np2 (second primary coil). However, according to circumstances, a winding number of the coil Np1 may be zero (0). In this case, only the coil Np2 functions as the primary coil.

An operation of the converter 1A is explained below with reference to FIGS. 1-4.

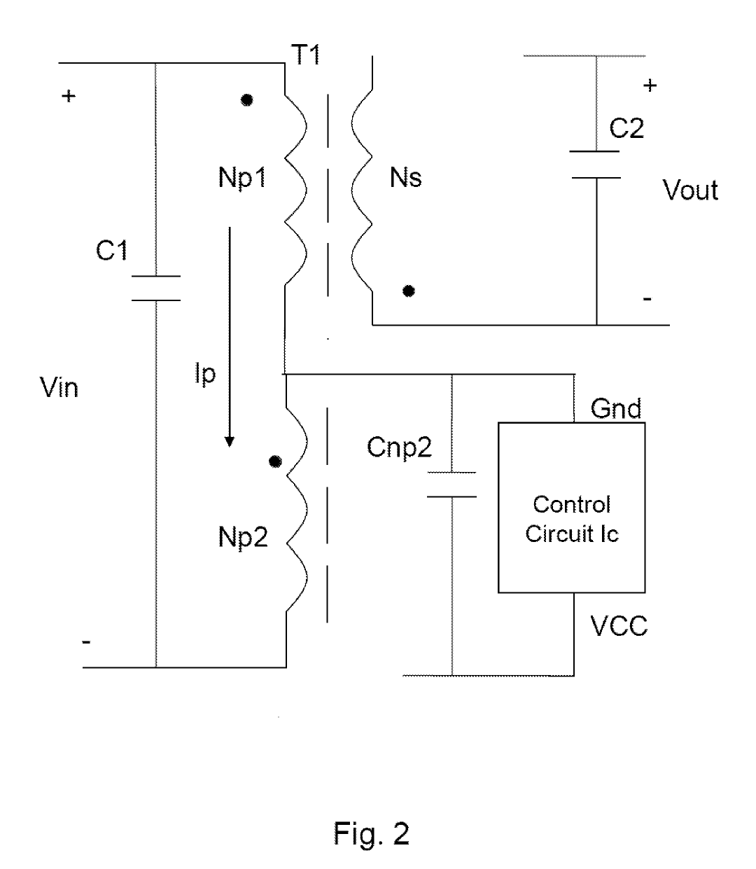

First, while the switching element Q1 (the first switching element) is turned ON (ON period Ton), the electric current Ip shown in FIG. 2 flows in a primary side of the transformer T1. At this time, the first rectifying element D1 and the second rectifying element D2 are biased in a backward direction. During this period, because a voltage, which is the same as a voltage between both terminals of the capacitor C1, is applied to the coil Np1 and the coil Np2, the electric current Ip flows in the primary coils Np1 and Np2. As a result, energy is accumulated in the transformer T1. Further, energy, which is charged in the capacitor C2, is supplied to the output terminal Vout.

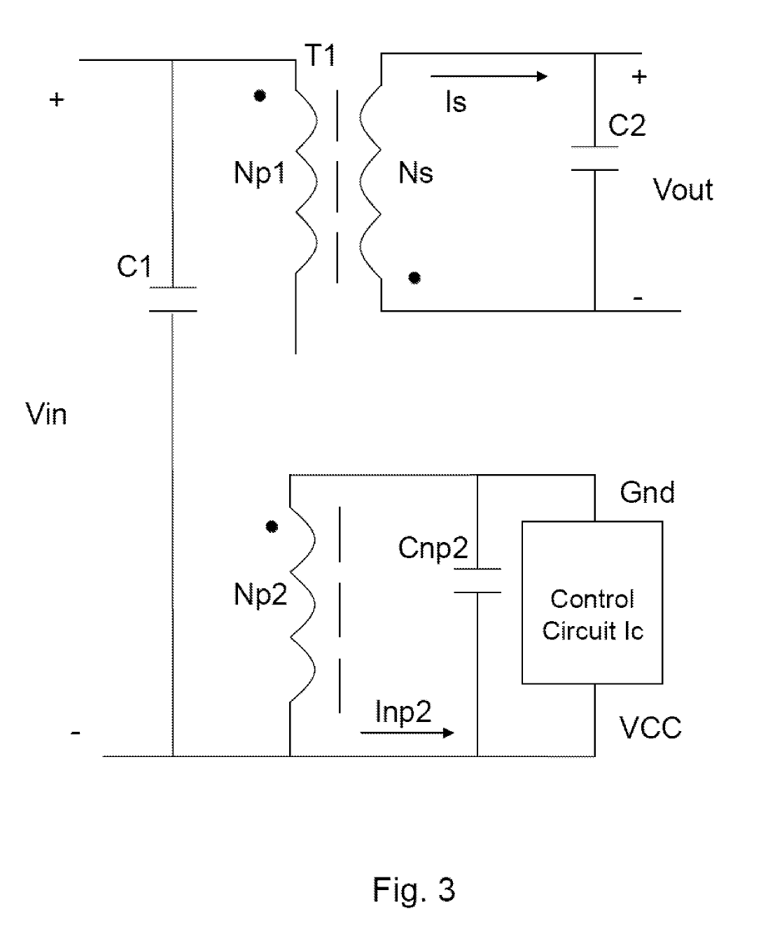

Next, while the switching element Q1 is turned Off (OFF period Toff), the first rectifying element D1 and the second rectifying element D2 are biased in a forward direction. As a result, the electric current Is shown in FIG. 3 flows in a secondary side of the transformer T1. Further, the electric current Inp2 flows in the coil Np2. During this period, energy is supplied to the output terminal Vout through the secondary coil Ns and the capacitor C2 is charged. Further, energy is supplied to the control circuit Ic that controls the switching element Q1 through the coil Np2 and the capacitor Cnp2 is charged.

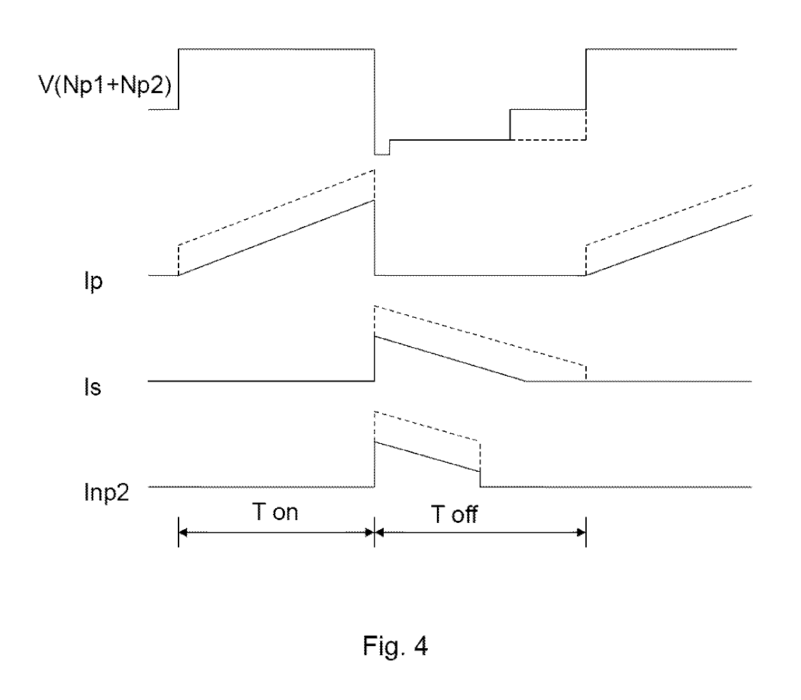

FIG. 4 is a waveform diagram that shows a total voltage V (Np1+Np2), the electric current Ip, the output electric current Is and the control circuit supply electric current Inp2 in the converter 1A according to the embodiment of the present invention. Specifically, the total voltage V (Np1+Np2) is applied to the coil Np1 and the coil Np2. The electric current Ip flows in the primary coils Np1 and Np2. The output electric current Is is supplied to the output terminal Vout through the secondary coil Ns. Further, the control circuit supply electric current Inp2 is supplied to the control circuit Ic through the coil Np2. In FIG. 4, Ton corresponds to the ON period of the switching element Q1 and Toff corresponds to the OFF period of the switching element Q1. During the ON period Ton of the switching element Q1, because the total voltage V (Np1+Np2), which is applied to the coil Np1 and the coil Np2 that are connected in series, moves to a high level, the electric current Ip, which flows in the primary coils Np1 and Np2, gradually increases. When the switching element Q1 is turned OFF, the output electric current Is generated by an induced voltage of the secondary coil Ns and the control circuit supply electric current Inp2 generated by an induced voltage of an auxiliary coil flow. Thereafter, during the OFF period Toff of the switching element Q1, the output electric current Is and the control circuit supply electric current Inp2 gradually decrease. When the capacitor Cnp2 is fully charged, the change of the control circuit supply electric current Inp2 is stopped. The dotted line corresponds to a waveform in an electric current consecutive mode. The solid line corresponds to a waveform in an electric current discontinuous mode. Both modes can be used in the converter 1A according to the embodiment of the present invention. During the OFF period Toff of the switching element Q1, energy, which is accumulated in the transformer T1, is supplied to the control circuit Ic and the output terminal Vout.

In the converter 1A according to the first embodiment, an auxiliary winding for supplying electric power to the control circuit Ic is not provided. During the OFF period Toff of the switching element Q1, electric power is supplied to the control circuit Ic by the coil Np2 which is a part of the primary coil Np. Further, during the ON period Ton of the switching element Q1, electric power is supplied to the control circuit Ic by the capacitor Cnp2 that is charged during the OFF period Toff. Therefore, the control circuit Ic can be operated constantly without providing an auxiliary winding. As a result, the converter can be miniaturized and the manufacturing costs can be reduced.

### Second Embodiment

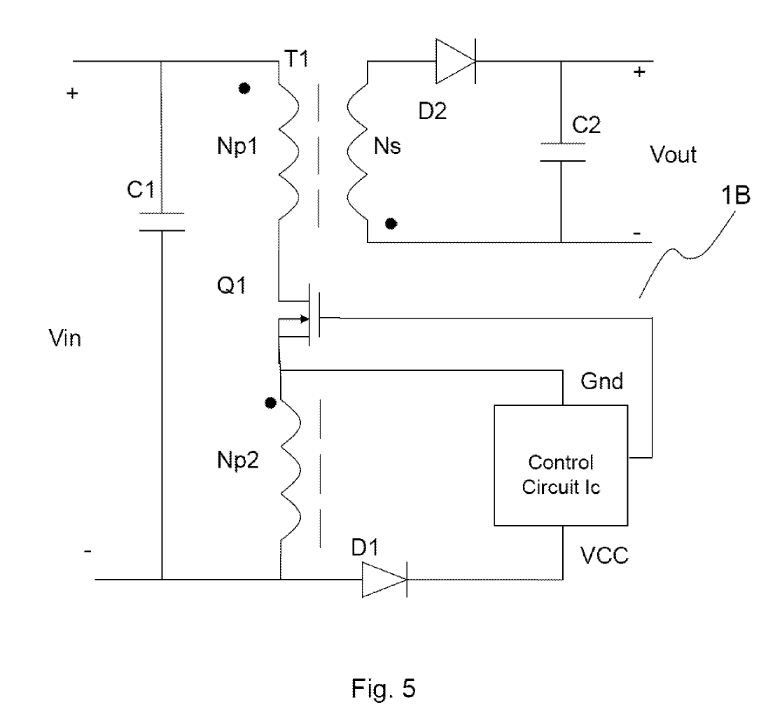

FIG. 5 is a circuit diagram that shows a converter according to a second embodiment of the present invention. The capacitor Cnp2 (not shown) is integrated into the control circuit IC in the converter 1B according to the second embodiment of the present invention. This is the main difference between the converter 1B and the converter 1A according to the first embodiment.

The converter 1B shown in FIG. 5 corresponds to a flyback converter. The converter 1B is configured with the input capacitor C1, the transformer T1, the capacitor C2, the first switching element Q1, the control circuit Ic, the first rectifying element D1 and the second rectifying element D2. Specifically, the transformer T1 has the primary coils Np1, Np2 and the secondary coil Ns. The first switching element Q1 is connected to the primary coils Np1 and Np2 in series. The control circuit Ic controls the first switching element Q1. The first rectifying element D1 supplies electric power to the control circuit Ic. Further, the second rectifying element D2 supplies electric power to the output terminal Vout. According to the embodiment of the present invention, a large capacity capacitor that is integrated in a chip is used as the control circuit Ic. The large capacity capacitor performs the same function as the capacitor Cnp2 according to the first embodiment of the present invention. Further, a ground potential Gnd of the control circuit Ic and the first rectifying element D1 are connected to the primary coils Np1 and Np2 at different points.

An operation of the converter 1B according to the second embodiment is the same as that of the converter 1A according to the first embodiment. Therefore, an explanation for the operation of the converter 1B is omitted here.

The converter 1B according to the second embodiment can accurately control a switching element as well as the converter 1A according to the first embodiment. At the same time, converter 1B can be miniaturized and the manufacturing costs can be reduced.

### Third Embodiment

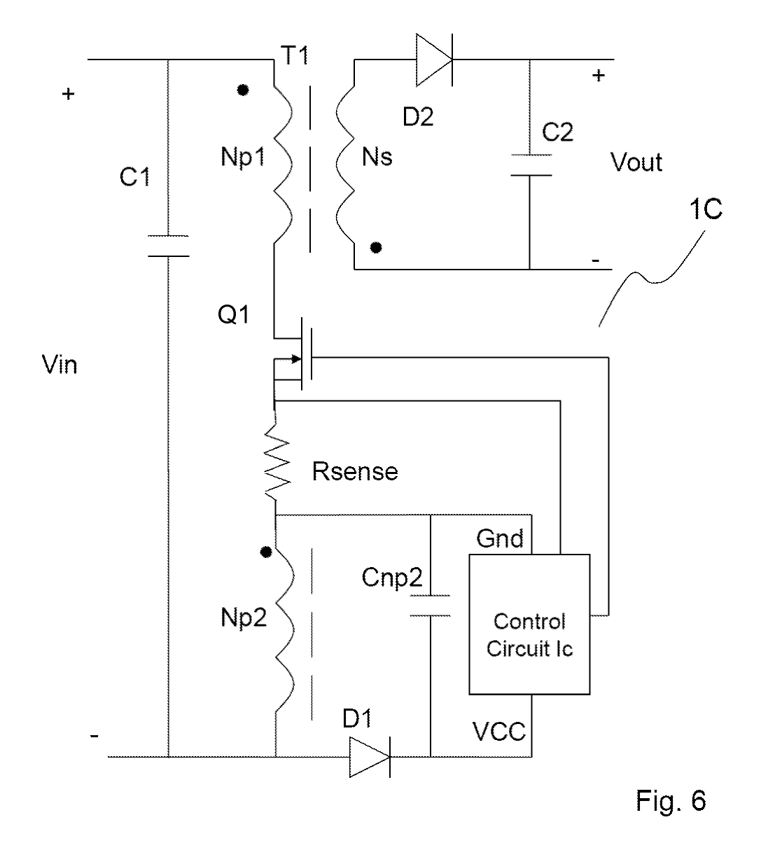

FIG. 6 is a circuit diagram that shows a converter according to a third embodiment of the present invention. In the converter 1C according to the third embodiment of the present invention, a ground potential Gnd of the control circuit Ic is connected to the switching element Q1 through a first resistor Rsense. This is the main difference between the converter 1C according to the third embodiment of the present invention and the converter 1A according to the first embodiment.

In the converter 1C shown in FIG. 6, the first resistor Rsense is provided between the switching element Q1 and the coil Np2 in addition to the configuration of the converter 1A according to the first embodiment. The first resistor Rsense is for detecting a sudden change of an electric current that flows in the primary coil Np.

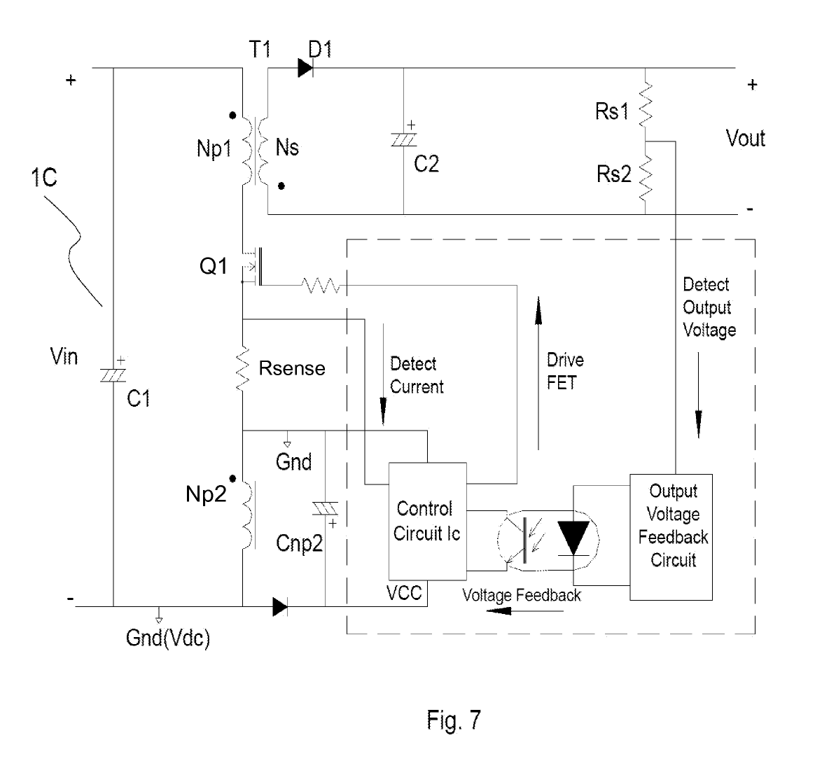

FIG. 7 is a circuit diagram that shows a connecting configuration of the control circuit Ic. As shown in FIG. 7, both ends of the first resistor Rsense are connected to the control circuit Ic. The control circuit Ic detects a voltage between both ends of the first resistor Rsense. When the voltage suddenly increases, for instance, the control circuit Ic turns the switching element Q1 OFF. As a result, an overcurrent in the primary coil Np can be prevented. Further, the control circuit Ic detects a voltage of a node connecting a resistor Rs1 and a resistor Rs2 that are located at the output terminal Vout. Then, the control circuit Ic transfers the detected voltage value to the control circuit Ic through a photocoupler. The control circuit Ic controls a duty ratio by which the switching element Q1 is turned ON and OFF so as to correspond the detected voltage to the target voltage.

Therefore, the control circuit Ic controls the output voltage to be stable. Further, during the OFF period Toff of the switching element Q1, electric power is provided to the control circuit Ic based on the electric current that flows in the coil Np2. During the ON period Ton of the switching element Q1, electric power is provided to the control circuit Ic from the capacitor Cnp2 that is charged during the OFF period Toff of the switching element Q1.

The converter 1C according to the third embodiment can accurately control a switching element as well as the converter 1A according to the first embodiment. At the same time, the converter 1C can be miniaturized and the manufacturing costs can be reduced. Further, an overcurrent that might flow in the primary coil can be prevented.

### Fourth Embodiment

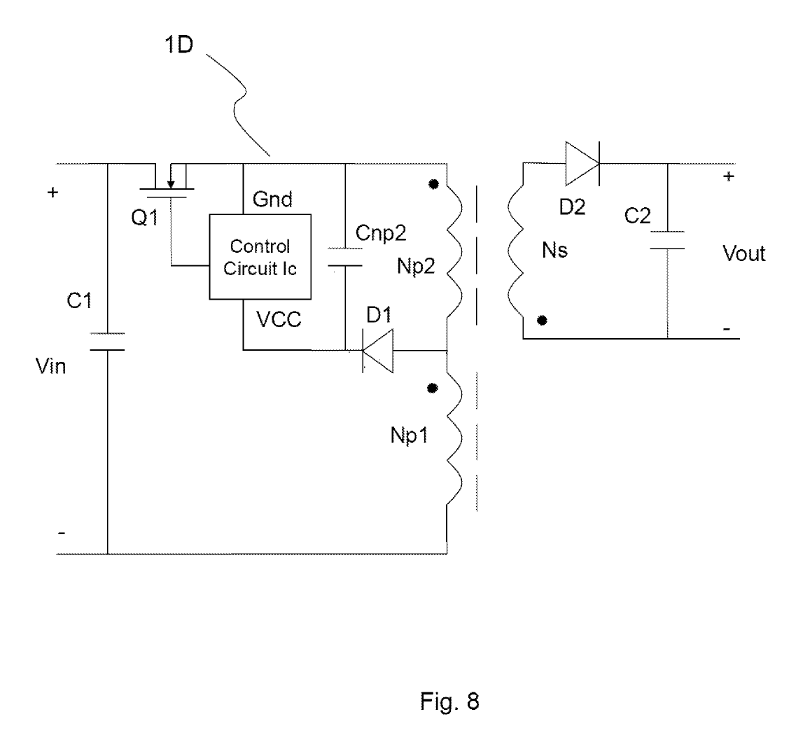

FIG. 8 is a circuit diagram that shows a converter according to a fourth embodiment of the present invention. In the converter 1D according to the fourth embodiment, the switching element Q1, the second primary coil Np2 and the first primary coil Np1 are connected in this order. This is the main difference between the converter 1D according to the fourth embodiment of the present invention and the converter 1A according to the first embodiment.

In the converter 1D according to the fourth embodiment of the present invention, the primary coil is divided into the coil Np1 (first primary coil) and the coil Np2 (second primary coil). However, according to circumstances, a winding number of the coil Np1 can be zero (0). In this case, only the second primary coil Np2 functions as the primary coil.

The first rectifying element D1 is connected to a node connecting the coil Np2 and the coil Np1. During the OFF period Toff of the switching element Q1, because the first rectifying element D1 is biased in a forward direction, the electric current Inp2 generated by an induced voltage flows in the coil Np2.

The converter 1D according to the fourth embodiment can save (omit) one pin of the transformer in addition to other advantages discussed in the previous embodiments. As a result, a further space-savings can be realized. Further, the converter 1D according to the fourth embodiment can accurately control a switching element. At the same time, the converter 1D can be miniaturized and the manufacturing costs can be reduced.

### Fifth Embodiment

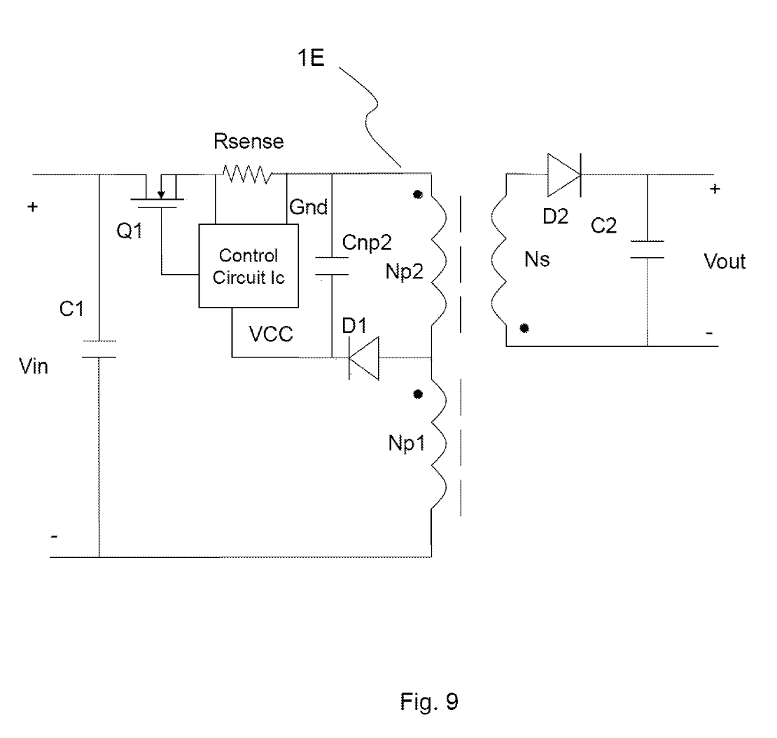

FIG. 9 is a circuit diagram that shows a converter according to a fifth embodiment of the present invention. In the converter 1E according to the fifth embodiment, a ground potential Gnd of the control circuit Ic is connected to the switching element Q1 through the first resistor Rsense. This is the main difference between the converter 1E according to the fifth embodiment of the present invention and the converter 1D according to the fourth embodiment of the present invention.

In the converter 1E shown in FIG. 9, the first resistor Rsense is provided between the switching element Q1 and the coil Np2 in addition to the configuration of the converter 1D according to the fourth embodiment. The first resistor Rsense is for detecting a sudden change of an electric current that flows in the primary coil Np.

A specific configuration of the control circuit Ic according to the fifth embodiment may be the same as the configuration of the control circuit Ic shown in FIG. 7 and also may be other known configurations.

The converter 1E according to the fifth embodiment can accurately control a switching element as well as the converter 1C according to the third embodiment. At the same time, the converter 1E can be miniaturized and the manufacturing costs of the converter 1E can be reduced. Further, an overcurrent that might flow in the primary coil can be prevented.

### Sixth Embodiment

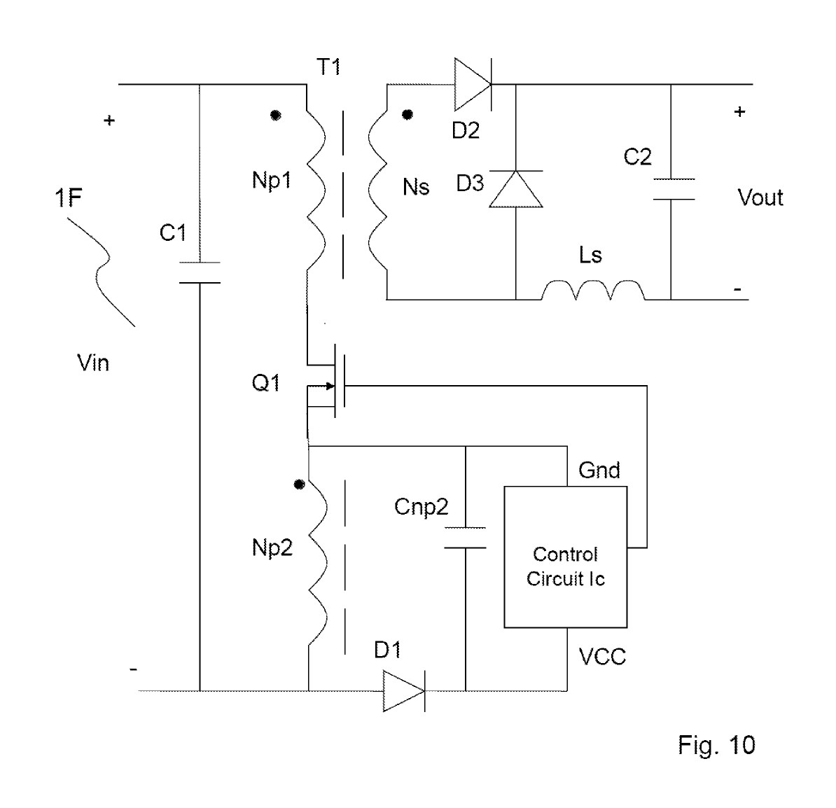

FIG. 10 is a circuit diagram that shows a converter according to a sixth embodiment of the present invention. The converter 1F according to the sixth embodiment corresponds to a forward converter. This is the main difference between the converter 1F according to the sixth embodiment of the present invention and the converter 1A according to the first embodiment of the present invention.

The converter 1F shown in FIG. 10 is different from the converter 1A according to the first embodiment in terms of the configuration of a side of the secondary coil Ns. A winding direction of the secondary coil Ns is reversed as compared with a winding direction of the secondary coil Ns of the converter 1A according to the first embodiment. The winding directions of the primary coils Np1, Np2 and the secondary coil Ns are the same in the converter 1F. Further, in the side of the secondary coil Ns, there are the second rectifying element D2, a third rectifying element D3, an inductor Ls, and the capacitor C2.

Next, during the ON period Ton of the switching element Q1, because the second rectifying element D2 is biased in a forward direction, the electric current Is flows in the secondary side of the transformer T1. During this period, energy is supplied to the output terminal Vout through the secondary coil Ns. Further, during the OFF period Toff of the switching element Q1, because the second rectifying element D2 is biased in a backward direction, energy, which is stored in the capacitor C2 and the inductor Ls, is supplied to the output terminal Vout.

The converter 1F according to the sixth embodiment can accurately control a switching element as well as the converter 1A according to the first embodiment. At the same time, the converter 1F can be miniaturized and the manufacturing costs of the converter 1F can be reduced.

Further, the secondary side of the configuration of the converter 1F according to the sixth embodiment which corresponds to the forward converter can be applied to the second through fifth embodiments as explained above. As a result, a corresponding forward converter can be configured in the second through fifth embodiments. When the present invention is applied to a flyback converter in which an operation is performed with low power, an efficiency improvement can be realized even more. However, even the forward converter that is configured as explained above can miniaturize the converter and reduce the manufacturing costs as well as the flyback converters according to the second through fifth embodiments.

### Seventh Embodiment

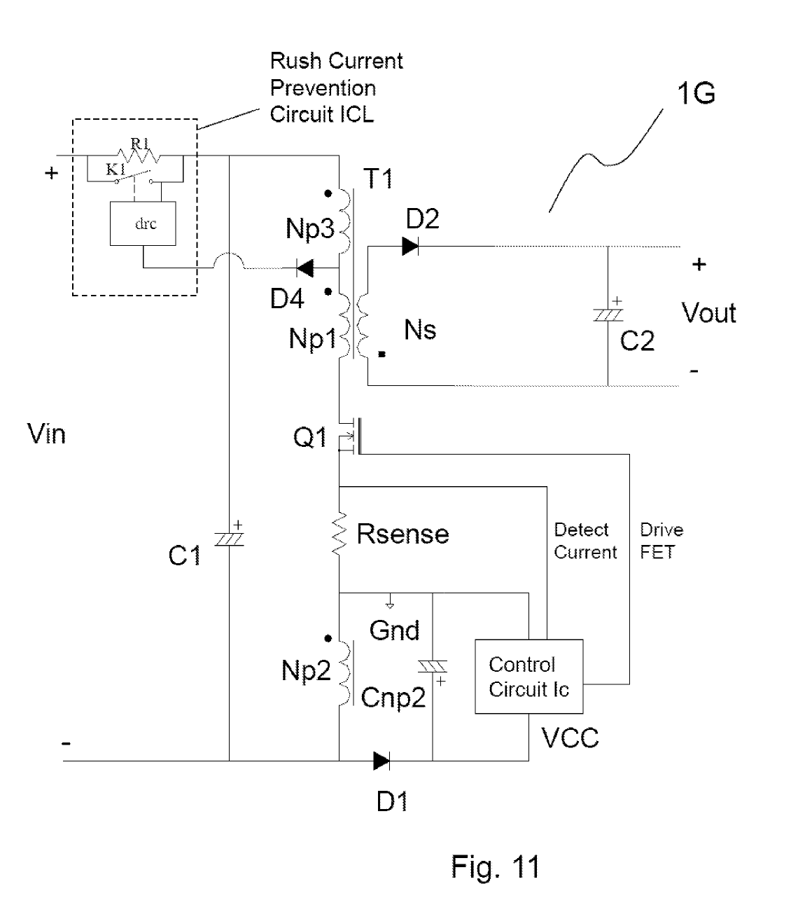

FIG. 11 is a circuit diagram that shows a converter according to a seventh embodiment of the present invention. The primary coil Np is divided into a first primary coil (Np1), a second primary coil (Np2) and a third primary coil (Np3) in the converter 1G according to the seventh embodiment. This is the main difference between the converter 1G according to the seventh embodiment and the converter 1C according to the third embodiment of the present invention.

The converter 1G shown in FIG. 11 is configured with the third primary coil (Np3) and a rush current prevention circuit ICL in addition to the configuration of the converter 1C according to the third embodiment. Specially, the coil Np1 of the converter 1C according to the third embodiment is further divided into the first primary coil Np1 and the third primary coil Np3. A fourth rectifying element D4 is connected to a node connecting the first primary coil Np1 and the third primary coil Np3. The rush current prevention circuit ICL is configured with a resistor R1 (a second resistor), a switching element K1 (a second switching element) and a drive circuit drc. Specifically, the resistor R1 is connected to the primary coil Np in series. The switching element K1 is connected to the resistor R1 in parallel. The drive circuit drc drives the switching element K1. The drive circuit drc is connected to the third primary coil Np3 through the fourth rectifying element D4. The switching element K1 can be, for instance, a relay, an FET, a transistor, a thyristor or a triac.

An operation of the rush current prevention circuit ICL will be explained below.

First, an input capacitor C1 is charged through the resistor R1. After the capacitor C1 is fully charged, an operation of the first switching element Q1 starts.

When the first switching element Q1 is turned ON, electric current flows in the primary coils (Np3, Np1, Np2). During this first ON period Ton, the electric current also flows in the resistor R1 because an initialization of the switching element K1 is OFF.

Next, when the first switching element Q1 is turned OFF, the fourth rectifying element D4 is biased in a forward direction. As a result, because the electric current flows in the fourth rectifying element D4, the switching element K1 is driven to be turned ON by the drive circuit drc. During this OFF period Toff of the first switching element Q1, the drive circuit drc holds energy for driving the switching element K1. For instance, the drive circuit drc may include a capacitor (not shown) that is charged by the electric current flowing in the fourth rectifying element D4.

Next, when the first switching element Q1 is turned ON again, the switching element K1 is maintained in an ON state as the above described situation.

In the rush current prevention circuit ICL as discussed above, when the operation of the first switching element Q1 is stopped, the drive circuit drc turns the switching element K1 OFF at the time of completely consuming energy held by the drive circuit drc.

Therefore, when power is turned ON the next time, the switching element K1 is set to be in an OFF state so that an electric current flows in the resistor R1. As a result, damage of an electric element by a rush current at the time of turning the power ON can be prevented.

The converter 1G according to the seventh embodiment can accurately control a switching element as well as the converter 1C according to the third embodiment. At the same time, the converter 1G can be miniaturized and the manufacturing costs can be reduced. Further, because the converter 1G can reduce the rush current at the time of turning the power ON, a false trigger of a breaker on a client side and damage of the electric element by the rush current at the time of turning the power ON can be prevented.

The converter being thus described, it will be apparent that the same may be varied in many ways. Such variations are not to be regarded as a departure from the spirit and scope of the invention, and all such modifications as would be apparent to one of ordinary skill in the art are intended to be included within the scope of the following claims.

What is claimed is:

1. A converter, comprising:
a transformer that has a primary coil and a secondary coil;
a first switching element that is serially connected to the primary coil;
a control circuit that controls the first switching element; and
a first rectifying element that supplies electric power to the control circuit, wherein
a ground potential of the control circuit and the first rectifying element are connected to the primary coil at different points.

2. The converter according to claim 1, wherein
the first rectifying element is connected to the primary coil so that an electric current flows in the first rectifying element when the first switching element is turned OFF.

3. The converter according to claim 1, wherein
the converter is a flyback converter or a forward converter.

4. The converter according to claim 1, further comprising:
a capacitor that is connected between an electric power supply terminal and the ground potential of the control circuit.

5. The converter according to claim 1, wherein
the primary coil is divided into a plurality of coils.

6. The converter according to claim 1, wherein
the primary coil is connected between an electric power supply terminal and the ground potential of the control circuit.

7. The converter according to claim 1, wherein
the ground potential of the control circuit is one of:
directly connected to the first switching element; or
connected to the first switching element through a first resistor.

8. The converter according to claim 2, wherein the ground potential of the control circuit is one of:
directly connected to the first switching element; or
connected to the first switching element through a first resistor.

9. The converter according to claim 4, wherein
the ground potential of the control circuit is one of:
directly connected to the first switching element; or
connected to the first switching element through a first resistor.

10. The converter according to claim 1, wherein
the primary coil is divided into a first primary coil and a second primary coil, and
the first switching element is provided between the first primary coil and the second primary coil.

11. The converter according to claim 2, wherein
the primary coil is divided into a first primary coil and a second primary coil, and
the first switching element is provided between the first primary coil and the second primary coil.

12. The converter according to claim 4, wherein
the primary coil is divided into a first primary coil and a second primary coil, and
the first switching element is provided between the first primary coil and the second primary coil.

13. The converter according to claim 1, wherein
the primary coil is divided into a first primary coil and a second primary coil, and
the first switching element, the second primary coil and the first primary coil are connected in this order.

14. The converter according to claim 2, wherein
the primary coil is divided into a first primary coil and a second primary coil, and
the first switching element, the second primary coil and the first primary coil are connected in this order.

15. The converter according to claim 4, wherein
the primary coil is divided into a first primary coil and a second primary coil, and
the first switching element, the second primary coil and the first primary coil are connected in this order.

16. The converter according to claim 1, wherein
the primary coil is divided into a first primary coil, a second primary coil and a third primary coil,
a first resistor is serially connected to the primary coil,
a second switching element is connected to the first resistor in parallel, and
the third primary coil is connected to a drive circuit, which drives the second switching element, through a second rectifying element that is different from the first rectifying element.

17. The converter according to claim 2, wherein
the primary coil is divided into a first primary coil, a second primary coil and a third primary coil,
a first resistor is serially connected to the primary coil,
a second switching element is connected to the first resistor in parallel, and
the third primary coil is connected to a drive circuit, which drives the second switching element, through a second rectifying element that is different from the first rectifying element.

18. The converter according to claim 4, wherein
the primary coil is divided into a first primary coil, a second primary coil and a third primary coil,
a first resistor is serially connected to the primary coil,
a second switching element is connected to the first resistor in parallel, and
the third primary coil is connected to a drive circuit, which drives the second switching element, through a second rectifying element that is different from the first rectifying element.
